(19) United States
(12) Patent Application Publication
(10) Pub. No.: US 2017/0159514 A1
(43) Pub. Date: Jun. 8, 2017

(54) CRANKSHAFT DRIVEN VALVE ACTUATION USING A CONNECTING ROD

(71) Applicant: BORG WARNER INC., Auburn Hills, MI (US)

(72) Inventors: Michael Loren SMART, Groton, NY (US); Mark WIGSTEN, Lansing, NY (US)

(21) Appl. No.: 15/325,172

(22) PCT Filed: Jul. 1, 2015
(86) PCT No.: PCT/US2015/038782

§ 371 Date: Jan. 10, 2017

Related U.S. Application Data
(60) Provisional application No. 62/025,255, filed on Jul. 16, 2014.

(51) Int. Cl. F01L 9/02; F15B 1/027; F15B 15/14; F01L 1/02

(52) U.S. Cl. CPC F01L 9/025; F01L 1/02; F15B 1/027; F15B 15/14

(57) ABSTRACT

A crankshaft driven valve actuation system (30), and methods of operation and assembly, for controlling opening and closing at least one hydraulically actuated engine valve (34a, 34b, 34c, 34d, 134a, 134b, 134c, 134d) associated with a cylinder of an internal combustion engine can include a crankshaft (50) driven by the engine, at least one fluid piston pump (36a, 36b) mounted for rotation on the crankshaft (50) for generating a reciprocating fluid flow in response to rotation of the crankshaft (50), a fluid passage providing fluid communication of the reciprocating fluid flow with one of the at least one hydraulically actuated valves to be controlled, and at least one control valve (56a, 56b, 56c, 56d) providing fluid flow between at least one accumulator (46, 46a, 46b, 46c, 46d) and the at least one fluid piston pump (36a, 36b) for modifying a valve timing actuation curve of the hydraulically actuated engine valve (34a, 34b, 34c, 34d, 134a, 134b, 134c, 134d) during reciprocal fluid flow.

### FIELD OF THE INVENTION

The invention relates to a method and apparatus for intake and exhaust valve actuation in internal combustion engines.

### BACKGROUND

An internal combustion engine generates power by burning fuel in a combustion chamber. Current intake and exhaust valves can be controlled and operated by camshafts and cams located in the engine. Intake valves can be opened in order to admit fuel and air into a cylinder for combustion, while exhaust valves can be opened to allow combustion gas to escape from the cylinder. The cams can be fixed profile cams which can provide difficulty in adjusting timings or amounts of engine valve lifts needed to optimize valve opening times and lift for varying engine operations. A lost motion device can be used between a valve and a cam on a camshaft for transmitting varying amounts of the cam motion to the valve. Current lost motion systems located between the cam on the camshaft and the valve use a master piston which displaces fluid from a hydraulic chamber into a hydraulic chamber of a slave piston. The slave piston can act on the engine valve for opening the valve. The hydraulic system generally includes added components such as cam sensors, oil control valves, phasers, guides, timing chains, tensioners, sprockets, bearing caps, and miscellaneous bolts and fasteners. The need for the added components in order to operate a lost motion system can increase valve train inertia, which can be problematic at high engine speeds. The added components can also increase complexity and cost. Valve actuation systems have been disclosed in U.S. Pat. No. 8,365,691; U.S. Pat. No. 6,997,148; U.S. Pat. No. 6,425,357; U.S. Pat. No. 5,645,031; U.S. Pat. No. 4,716,3; U.S. Pat. No. 2,072,437; U.S. Patent Application No. 2011/0197833; and W.O. Patent Application No. 2007/142724.

### SUMMARY

It can be desirable to minimize the additional components by entirely eliminating various components, by way of example and not limitation, such as camshafts, bearings, timing chains, guides, sprockets, tensioners, and phasers. It can also be desirable to eliminate the camshaft as an additional component due to the added size and weight that the camshaft adds to the valve train. To overcome the limitation of current technology, the disclosed crankshaft driven valve actuation system eliminates the camshaft and uses at least one connecting rod mounted for rotation with respect to a crankshaft by a crankpin located on the crankshaft. The at least one connecting rod can be operable for reciprocating a master piston for pressurizing fluid to drive reciprocal fluid flow within the crankshaft driven valve actuation system. The use of a connecting rod can eliminate added components currently used in valve actuation systems such as the cam sensors, oil control valves, phasers, guides, timing chains, tensioners, sprockets, bearing caps, and miscellaneous bolts and fasteners. The crankshaft driven valve actuation system can control the opening and closing of a plurality of hydraulically actuatable valves, either intake valves or exhaust valves, or both intake and exhaust valves. The valves can be associated with a plurality of cylinders of an internal combustion engine. The crankshaft driven valve actuation system can include at least one accumulator for reciprocally receiving and releasing fluid in a lost motion manner when modification of valve actuation is desired, and for maintaining fluid pressure and volume in the crankshaft driven valve actuation system.

A crankshaft driven valve actuation system can include a crankshaft driven by the engine and rotatable about a primary longitudinal rotational axis and at least one fluid piston pump connected to the crankshaft for generating a reciprocating fluid flow in response to rotation of the crankshaft. The system can include at least one control valve operable for isolating and providing fluid flow between the at least one accumulator and the at least one fluid piston pump. The fluid piston pump can include a master piston, a fluid pumping chamber, and at least one fluid passage corresponding to at least one of a plurality of hydraulically actuatable valves. The master piston can be operable for reciprocally driving fluid in and out of the at least one fluid passage with respect to the fluid pumping chamber. The system can include a connecting rod connected between the crankshaft and the master piston operable for reciprocating the master piston for reciprocally driving fluid toward the at least one fluid passage and for reciprocally drawing fluid out of the at least one fluid passage. The connecting rod can push or pull the master piston within the fluid pumping chamber creating sufficient working fluid pressure and volume to operably actuate one or more of a plurality of valves in fluid communication with the crankshaft driven valve actuation system as fluid flow reciprocates within the crankshaft driven valve actuation system fluid passages in response to reciprocation of the master piston driven by the connecting rod corresponding to rotation of the crankshaft. The at least one accumulator can provide a lost motion function for modifying a valve timing actuation curve of the hydraulically actuated valves during reciprocal fluid flow, while maintaining working fluid volume and pressure during the operating cycle and to make up for working fluid volume losses and pressure losses due to normal leakage during operation cycles. The working fluid, being an essentially incompressible working fluid, can allow reciprocal flowing movement of the working fluid through the crankshaft driven valve actuation system in response to reciprocal movement of the master piston as the master piston is driven by rotation of the connecting rod by the crankshaft. The master piston is in continuous fluid communication with the crankshaft driven valve actuation system fluid passages during operation of the internal combustion engine.

A method of operating a normally closed valve associated with one of a plurality of cylinders in a crankshaft driven valve actuation system of an internal combustion engine is disclosed. The crankshaft driven valve actuation can include at least one accumulator for maintaining fluid pressure and volume in the system. The method can include rotating a crankshaft of the internal combustion engine about a primary longitudinal rotational axis. The crankshaft can be connected to at least one fluid piston pump by a connecting rod. The method can further include generating a reciprocating fluid flow by the at least one fluid piston pump in response to rotation of the crankshaft, selectively providing fluid communication between a fluid pumping chamber of the at least one fluid piston pump and the valve to be controlled with the reciprocating fluid flow within fluid passages for driving the valve between a normally closed position and an open position in response to the reciprocating fluid flow, and selectively communicating at least one control valve for selectively providing fluid flow between the at least one accumulator and the at least one fluid piston pump for operating as a lost motion mechanism when modification or elimination of a valve timing actuation curve is desired during reciprocal fluid flow.

A method of assembling a crankshaft driven valve actuation system for controlling opening and closing a plurality of hydraulically actuated valves, either intake valves or exhaust valves or both intake and exhaust valves, can be used for valves associated with a corresponding plurality of cylinders in an internal combustion engine. The crankshaft driven valve actuation system can include a crankshaft driven by the engine and rotatable about a primary longitudinal rotational axis, and at least one accumulator for redirecting pressurized fluid reciprocating fluid flow to operate as a lost motion mechanism to modify valve actuation when desired. The method can include connecting a connecting rod to the crankshaft for rotation with respect to the crankshaft, assembling at least one fluid piston pump for reciprocation in response to rotation of the connecting rod by the crankshaft, connecting the at least one fluid pressure pump to at least one fluid passage for directing reciprocal fluid flow from the at least on fluid pressure pump in fluid communication with at least one valve to be controlled, and inserting at least one control valve operable for providing lost motion fluid flow between the at least one accumulator and the at least one fluid piston pump to modify valve timing actuation curve during reciprocal fluid flow. The method can include assembling a master piston reciprocally within a fluid pumping chamber of the at least one fluid pressure piston pump for generating reciprocal fluid flow in response to rotation of the connecting rod. The method can include connecting a linkage mechanism between the at least one fluid piston pump and the connecting rod for transferring reciprocal motion of the connecting rod to drive fluid toward the at least one fluid passage and to draw fluid from the at least one fluid passage.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a schematic view of a crankshaft driven valve actuation system for selectively controlling four intake valves and four exhaust valves including a crankshaft, an internal combustion engine valve assembly, including both intake and exhaust valves, and a crankshaft driven valve actuation system illustrating two connecting rods connected to the crankshaft to be driven in rotation by the crankshaft of an internal combustion engine for driving first and second master pistons in reciprocal movement between first and second positions to create a reciprocal fluid flow within two separate closed fluid flow paths, four control valves, each control valve movable between a first position operable for allowing fluid communication between the master piston chamber and the accumulator, and at least one switching valve for selectively allowing and preventing fluid communication between an expandable fluid chamber associated with each valve to be actuated and the closed fluid flow path;

FIG. 2 is a schematic of the crankshaft driven valve actuation system for selectively controlling the opening of a single valve illustrating a first control valve operable between a first closed position and a second open position for selectively controlling fluid communication between the master piston chamber and the accumulator for lost motion fluid flow when modification of valve actuation is desired;

FIG. 3 is a detailed schematic illustrating the connecting rod with a linkage mechanism for driving the master piston; and

FIG. 4 is a detailed schematic illustrating the connecting rod according to the present invention directly driving the master piston.

### DETAILED DESCRIPTION

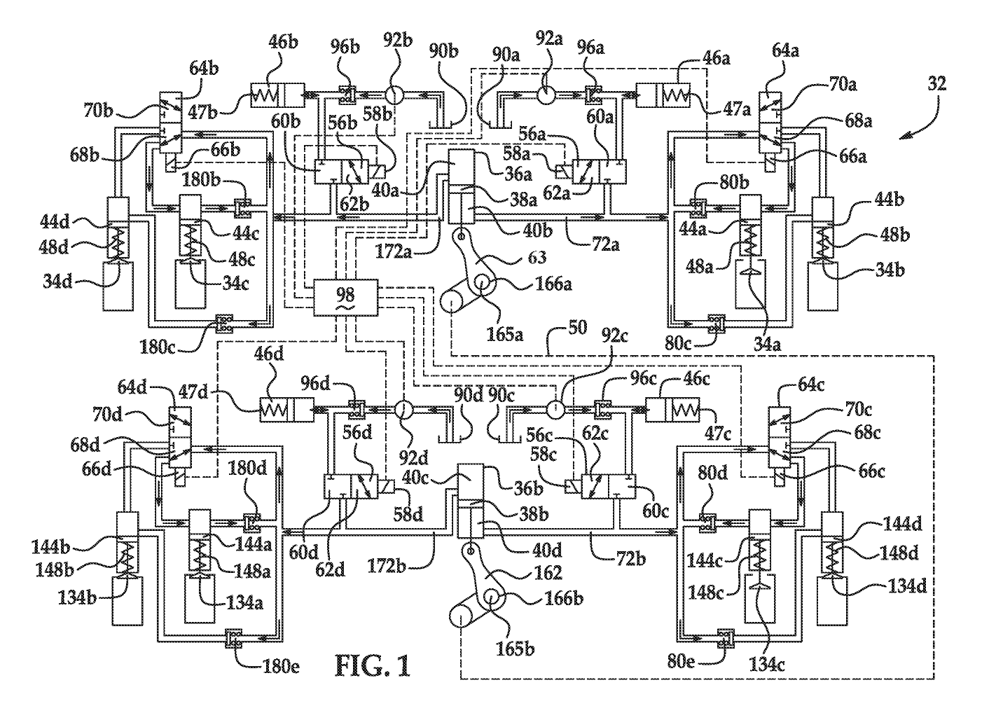

Referring now to FIGS. 1-4, a crankshaft driven valve actuation system 30 for controlling opening and closing of a plurality of hydraulically actuated valves 34a, 34b, 34c, 34d, 134a, 134b, 134c, 134d, either intake valves, exhaust valves, or both intake and exhaust valves, corresponding to a plurality of cylinders of an internal combustion engine is illustrated. The system can include a plurality of slave pistons 44a, 44b, 44c, 44d, 144a, 144b, 144c, 144d corresponding to the plurality of valves 34a, 34b 34c, 34d, 134a, 134b, 134c, 134d. Each of the plurality of slave pistons 44a, 44b, 44c, 44d, 144a, 144b, 144c, 144d can be normally biased by a spring 48a, 48b, 48c, 48d, 148a, 148b, 148c, 148d toward a normally closed valve position, and can be hydraulically driven with fluid pressure sufficiently high to overcome the biasing force of the spring toward an open valve position. The crankshaft driven valve actuation system 30 can include at least one accumulator 46, 46a, 46b, 46c, 46d operable for receiving and releasing fluid volume for providing a lost motion fluid flow when modification of valve actuation is desired, and for maintaining fluid pressure and volume in the crankshaft driven valve actuation system 30. By way of example and not limitation, the crankshaft driven valve actuation system 30 can be used in a four-stroke internal combustion engine having a plurality of hydraulically actuated valves 34a, 34b, 34c, 34d, 134a, 134b, 134c, 134d, either intake valves, exhaust valves, or both intake and exhaust valves.

Referring now to FIG. 1, a crankshaft driven valve actuation system 30 using a pair of connecting rods 62, 162 for controlling opening and closing a plurality of hydraulically actuated intake valves 34a, 34b, 34c, 34d, and a plurality of hydraulically actuated exhaust valves 134a, 134b, 134c, 134d corresponding to a plurality of cylinders of an internal combustion engine is illustrated. Each cylinder can include an intake valve 34a, 34b, 34c, 34d and a corresponding exhaust valve 134a, 134b, 134c, 134d. Each of the plurality of valves 34a, 34b, 34c, 34d, 134a, 134b, 134c, 134d can have a corresponding slave piston 44a, 44b, 44c, 44d, 144a, 144b, 144c, 144d. Each slave piston 44a, 44b, 44c, 44d, 144a, 144b, 144c, 144d can be normally biased by a spring 48a, 48b, 48c, 48d, 148a, 148b, 148c, 148d toward a first position. The first position can be defined by the valve 34a, 34b, 34c, 34d, 134a, 134b, 134c, 134d in a closed position. Each slave piston 44a, 44b, 44c, 44d, 144a, 144b, 144c, 144c can be hydraulically driven with fluid pressure sufficiently high to overcome the biasing force of the spring 48a, 48b, 48c, 48d, 148a, 148b, 148c, 148d toward a second position. The second position can be defined by the valve 34a, 34b, 34c, 34d, 134a, 134b, 134c, 134d in an open position. The crankshaft driven valve actuation system 30 can include at least one accumulator 46, 46a, 46b, 46c, 46d operable for receiving and releasing fluid volume for providing a lost motion fluid flow when modification of valve actuation is desired, and for maintaining fluid pressure and volume in the crankshaft driven valve actuation system 30. It should be recognized by those skilled in the art that lost motion fluid flow can be used to modify a valve timing curve or completely discard valve actuation if desired. By way of example and not limitation, the crankshaft driven valve actuation system 30 can be used in a four-stroke internal combustion engine having a first, second, third and fourth cylinders. Each cylinder can have a corresponding hydraulically actuated intake valve 34a, 34b, 34c, 34d and corresponding hydraulically actuated exhaust valve 134a, 134b, 134c, 134d. The hydraulically actuated valves operable by the valve actuation system 30 can be either intake valves, exhaust valves, or both intake and exhaust valves.

The crankshaft driven valve actuation system 30 can include at least one fluid piston pump 36, 36a, 36b having a master piston 38, 38a, 38b for movement within a housing defining at least one fluid pumping chamber 40, 40a, 40b, 40c, 40d. The fluid pumping chamber can provide a source of pressurized fluid in fluid communication with the plurality of valves 34a, 34b, 34c, 34d, 134a, 134b, 134c, 134d and the accumulator 46, 46a, 46b, 46c, 46d through fluid passages defining a reciprocal fluid flow path. The valve actuation system 30 can include a crankshaft 50 rotatable by the engine about a primary longitudinal rotational axis and crankpins 65a, 65b located on the crankshaft 50 and angularly offset with respect to one another. By way of example and not limitation, the crankpins 65a, 65b can be offset approximately 220° with respect to one another for controlling intake valves off from rotation of crankpin 65a and for controlling exhaust valves off from rotation of crankpin 65b. The valve actuation system 30 can include at least one connecting rod 62, 162 associated between the crankshaft 50 and the master piston 38, 38a, 38b. The at least one connecting rod 62, 162 can be mounted for rotation with respect to the crankshaft 50 on the crankpin 165a, 165b by at least one rod bearing 166a, 166b and operable for reciprocating the master piston 38, 38a, 38b between a first position in the at least one fluid pumping chamber 40, 40a, 40b, 40c, 40d and a second position in the at least one fluid pumping chamber 40, 40a, 40b, 40c, 40d. The master piston 38, 38a, 38b can pressurize a working fluid located in the at least one fluid pumping chamber 40, 40a, 40b, 40c, 40d for reciprocal flow through a plurality of fluid passages 72, 72a, 72b, 172a, 172b located in the crankshaft driven valve actuation system 30. The master piston 38, 38a, 38b can pressurize fluid toward a first fluid passage 72, 72a, 72b, when in the first position and can pressurize fluid toward a second fluid passage 172a, 172b when in the second position. The first and second position can be used for opening different sets of valves 34a, 34b; 34c, 34d; 134a, 134b; 134c, 134d. By way of example and not limitation, when master piston 38a, 38b are in the first position, pressurized fluid is in fluid communication with first fluid passages 72a, 72b enabling pressurized fluid to be directed to slave pistons 48a, 48b 148c, 148d depending on the position of control valves 64a, 64c, and when master piston 38a, 38b is in the second position, pressurized fluid is in fluid communication with second fluid passages 172, 172b enabling pressurized fluid to be directed to slave pistons 48c, 48d, 148a, 148b depending on the position of control valves 64b, 64d.

The actuation system 30 can include at least one control valve 56, 56a, 56b, 56c, 56d operable by a actuator 58, 58a, 58b, 58c, 58d between a first position 60a, 60b, 60c, 60d and a second position 62a, 62b, 62c, 62d. By way of example and not limitation, a control valve 56, 56a, 56b, 56c, 56d can have an actuator 58, 58a, 58b, 58c, 58d, such as a solenoid operated actuator, a piezoelectric operated actuator, or any other mechanically or electrically operated actuator for a control valve. The at least one control valve 56, 56a, 56b, 56c, 56d can provide fluid communication between the at least one fluid piston pump 36, 36a, 36b and the at least one accumulator 46, 46a, 46b, 46c, 46d. The first position 60a, 60b, 60c, 60d can be defined by preventing fluid communication between the at least one accumulator 46, 46a, 46b, 46c, 46d and the fluid passages 72, 72a, 72b, 172a, 172b. The second position 56c, 156c can be defined by providing fluid communication between the fluid passages 72, 72a, 72b, 172a, 172b and the at least one accumulator 46, 46a, 46b, 46c, 46d providing for fluid communication between the at least one fluid piston pump 36, 36a, 36b and the at least one accumulator 46, 46a, 46b, 46c, 46d.

By way of example and not limitation, a four stroke-four cylinder cycle can refer to travel of an engine piston between an intake stroke, a compression stroke, an ignition/combustion/power stroke, and an exhaust stroke, such that the at least one connecting rod 62, 162 can reciprocate the master piston 38 between a first and second position within the fluid pumping chamber 40, 40a, 40b, 40c, 40d to force fluid into the first or second fluid passages 72, 72a, 72b, 172a, 172b in order to open one of the two of the plurality of valves 34a, 34b; 34c, 34d; 134a, 134b; 134c, 134d based on the position of the corresponding at least one switching valve 64a, 64b, 64c, 64d. By way of example and not limitation, the valves 34a, 34b, 134c, 134d can correspond to two intake valves 34a, 34b associated with a first and fourth cylinder and two exhaust valves 134c, 134d associated with the second and third cylinder of a four cylinder internal combustion engine, while the valves 34c, 34d, 134a, 134b can correspond to two intake valves 34c, 34d associated with second and third cylinders and two exhaust valves 134a, 134b associated with a first and fourth cylinders of a four cylinder internal combustion engine. In other words, the first cylinder can be associated with intake valve 34a and exhaust valve 134a, the fourth cylinder can be associated with intake valve 34b and exhaust valve 134b, the second cylinder can be associated with intake valve 34c and exhaust valve 134c, and the third cylinder can be associated with intake valve 34d and exhaust valve 134d.

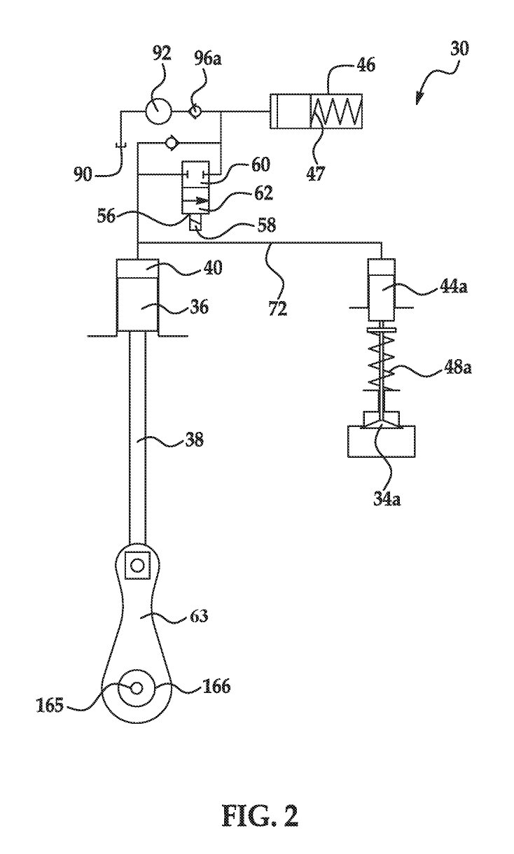

As illustrated in FIG. 2, the crankshaft driven valve actuation system 30 can operate directly to open a single valve 34a, either an intake valve or an exhaust valve. It should be recognized that a plurality of connecting rods 62 can be provided mounted on the crankshaft 50 for driving reciprocal fluid flow through separate closed fluid flow paths for opening each valve, either intake valves and/or exhaust valve, individually. It should further be recognized that a single connecting rod 62 can drive one master piston pump 36 to provide a source of pressurized fluid for reciprocal flow in one closed fluid flow path 72 or one master piston pump 36 to provide a source of pressurized fluid for reciprocal flow in multiple closed fluid paths 72a, 172a; 72b, 172b. By way of example and not limitation, it should also be recognized by those skilled in the art, that the opening and closing of two valves 34a, 34b, either intake or exhaust valves, for different cylinders of an internal combustion engine can be actuated with a single master piston pump 38 driving reciprocal pressurized fluid flow within a single closed fluid flow path 72 with a single control valve 56 selectively allowing communication with an accumulator 46 to provide lost motion pressurized fluid reciprocation when valve actuation is not desired or when modification of valve actuation is desired. Optionally, as illustrated in FIG. 1, a single switching valve 64a, 64b, 64c, 64d can be added for selectively directing reciprocal fluid flow to one of the two valves 34a, 34b; 34c, 34d; 134a, 134b; 134c, 134d to be controlled.

As illustrated in FIG. 1, the crankshaft driven valve actuation system 30 disclosed can be used in a four cylinder internal combustion engine. FIG. 1 shows eight control valves corresponding to the four cylinders. Each cylinder can have an intake valve 34a, 34b, 34c, 34d and an exhaust valve 134a, 134b, 134c, 134d. A connecting rod 62, 162 can be associated with each group of four valves out of the eight control valves, or with each group of two valves out of the eight control valves, or with each valve out of the eight control valves, or any combination thereof. The disclosed crankshaft driven valve actuation system 30 can be used for cylinders having a four-stroke cycle, but it is contemplated that the system could be used in a two-stroke engine. It is contemplated that the crankshaft driven valve actuation system 30 can be used with internal combustion engines having any desired number of cylinders, by way of example and not limitation, such as one cylinder, two cylinder, three cylinder, four cylinder, six cylinder or eight cylinder engines. It is contemplated that the crankshaft driven valve actuation system 30 can be used in an internal combustion engine for controlling both intake and exhaust valves as illustrated in FIGS. 1-2.

By way of example and not limitation, as illustrated in FIG. 1, a first switching valve 64a can selectively control fluid communication between the pressurized fluid passage 72a and a first valve 34a or a second valve 34b; a second switching valve 64b can selectively control fluid communication between the pressurized fluid passage 172a and a third valve 34c or a fourth valve 34d; a third switching valve 64c can selectively control fluid communication between the pressurized fluid passage 72b and a fifth valve 134c or a sixth valve 134d; and a fourth switching valve 64d can selectively control fluid communication between the pressurized fluid passage 172b and a seventh valve 134a or a eighth valve 134b. In other words, the system can include a first, second, third, and fourth switching valve 64a, 64b, 64c, 64d for selectively controlling a corresponding pair of first and second valves 34a, 34b; 34c, 34d; 134c, 134d; 134a, 134b. Each of the first, second, third, and fourth switching valve 64a, 64b, 64c, 64d can be moved between a first position 68a, 68b, 68c, 68d and a second position 70a, 70b, 70c, 70d for switching fluid communication between a first slave piston 44a, 44d, 144c, 144a and second slave piston 44b, 44c, 144d, 144b, respectively. Each of the first, second, third, and fourth switching valve 64a, 64b, 64c, 64d can be driven from the first position toward the second position by a corresponding actuator 66a, 66b, 66c, 66d. By way of example and not limitation, a switching valve 64a, 64b, 64c, 64d can have an actuator 66a, 66b, 66d, 66d, such as a solenoid operated actuator, a piezoelectric operated actuator, or any other mechanically or electrically operated actuator for a switching valve.

The simplified schematic of FIG. 1 illustrates master pistons 38a, 38b in synchronized motion offset approximately 360° of crankshaft rotation with respect to one another for simplicity, while it should be recognized by those skilled in the art that the exhaust valve master piston 38b is reciprocated with an offset of approximately 220° of crankshaft rotation from the intake valve master piston 38a, and the description herein should be read and interpreted accordingly. In other words, by way of example and not limitation, the intake valve 34a and exhaust valve 134a can be actuated approximately 220° from one another for the first cylinder; the intake valve 34b and exhaust valve 134b can be actuated approximately 220° from one another for the fourth cylinder; the intake valve 34c and exhaust valve 134c can be actuated approximately 220° from one another for the second cylinder; and the intake valve 34d and exhaust valve 134d can be actuated approximately 220° from one another for the third cylinder. By way of example and not limitation to accomplish the necessary offset for actuation of the intake and exhaust valves, crankpin 165a can be offset approximately 220° from crankpin 165b.

The first position of the first and second master pistons 38a, 38b can be defined by pressurized fluid being driven out of the fluid chambers 40a, 40c into corresponding first fluid passages 72a, 72b for selectively opening intake valve 34a or 34b and exhaust valve 134c or 134d depending on the position of control valves 64a and 64c, or for selectively being diverted for lost motion to accumulator 46a or 46c depending on the position of control valves 56a, 56c. When the first and second master pistons 38a, 38b are driven to the first position, fluid is drawn into pump chambers 40b, 40d from fluid passages 172a, 172b for selectively closing intake valve 34c or 34d and exhaust valve 134a or 134b depending on the position of control valves 64b, 64d, or for selectively being diverted for lost motion to accumulator 46b, 46d depending on the position of the control valves 56b, 56d.

The second position of the master piston 38a, 38b can be defined by pressurized fluid being driven out of fluid chambers 40b, 40d into corresponding second fluid passages 172a, 172b for selectively opening intake valve 34c or 34d and exhaust valve 134a or 134b depending on the position of control valves 64b and 64d, or for selectively being diverted for lost motion to accumulator 46b or 46d depending on the position of control valves 56b, 56d. When the first and second master pistons 38a, 38b are driven to the second position, fluid is drawn into pump chambers 40a, 40c from fluid passages 72a, 72b for selectively closing intake valve 34a or 34b and exhaust valve 134c or 134d depending on the position of control valves 64a, 64c, or for selectively being diverted for lost motion to accumulator 46a, 46c depending on the position of the control valves 56a, 56c.

As illustrated in FIG. 1, by way of example and not limitation for purposes of the description herein, the crankshaft 50 is shown in a first rotational position identified herein as a 0° position, or an initial configuration of the crankshaft 50. The connecting rod 62, 162 can be rotated around the crankpin 165a, 165b such that the connecting rod 62, 162 can push the master piston 38a, 38b in the fluid pumping chamber 40a, 40b toward a first position. In the first position, the master pistons 38a, 38b can expel pressurized fluid from pump chambers 40a, 40c into corresponding first fluid passages 72a, 72b, while drawing fluid into pump chambers 40b, 40d from corresponding second fluid passages 172a, 172b. In the second position, the master pistons 38a, 38b can expel pressurized fluid from chambers 40b, 40d into corresponding second fluid passages 172a, 172b, while drawing fluid into pump chambers 40a, 40c from corresponding first fluid passages 72a, 72b.

By way of example and not limitation, the crankshaft driven valve actuation system 30 can operate as indicated in the following table.

| | | Crankshaft Position | | | | | | | |
|---|---|---|---|---|---|---|---|---|---|
| Control Valve | Position | 0° | 40° | 180° | 220° | 360° | 400° | 540° | 580° |
| 64a | 1^{st} | 34a | | 34a | | | | 34a | |
| | | 34b | | 34b | | | | 34b | |
| | 2^{nd} | | | 34a | | 34a | | 34a | |
| | | | | 34b | | 34b | | 34b | |
| 64b | 1^{st} | 34c | | 34c | | 34c | | | |
| | | 34d | | 34d | | 34d | | | |
| | 2^{nd} | 34c | | | | 34c | | 34c | |
| | | 34d | | | | 34d | | 34d | |
| 64c | 1^{st} | | | | 134c | | 134c | | 134c |
| | | | | | 134d | | 134d | | 134d |
| | 2^{nd} | | 134c | | 134c | | | | 134c |
| | | | 134d | | 134d | | | | 134d |
| 64d | 1^{st} | | 134a | | 134a | | 134a | | |
| | | | 134b | | 134b | | 134b | | |
| | 2^{nd} | | 134a | | | | 134a | | 134a |
| | | | 134b | | | | 134b | | 134b |

=VALVE OPEN
=VALVE CLOSED
(where valve designations are as follows: cylinder #1 = intake 34a, exhaust 134a; cylinder #4 = intake 34b, exhaust 134b; cylinder #2 = intake 34c, exhaust 134c; and cylinder #3 = intake 34d, exhaust 134d)

When the crankshaft is in the 0° position and the switching valves 64a, 64b, 64c are in a first position 68a, 68b, 68c and switching valve 64d is in a second position 70d, the first intake valve 34a can be in an open position and exhaust valve 134b can be closing, while the remaining valves 34b, 34c, 34d, 134a, 134c, 134d remain closed. When the crankshaft is in the 40° position and the switching valves 64a, 64b, 64d are in a first position and switching valve 64c is in the second position 70c, the fourth exhaust valve 134d can be in an open position and intake valve 34a can be closing, while the remaining valves 34b, 34c, 34d, 134a, 134b, 134c remain closed. When the crankshaft is in the 180° position and the switching valves 64a, 64b, 64d are in a first position 68a, 68b, 68d and switching valve 64c is in a second position 70c, the third intake valve 34c can be in an open position and exhaust valve 134d can be closing, while the remaining valves 34a, 34b, 34d, 134a, 134b, 134c remain closed. When the crankshaft is in the 220° position and the switching valves 64a, 64b, 64c, 64d are in a first position 68a, 68b, 68c, 68d, the first exhaust valve 134a can be in an open position and intake valve 34c can be closing, while the remaining valves 34a, 34b, 34d, 134b, 134c, 134d remain closed. When the crankshaft is in the 360° position and the switching valves 64b, 64c, 64d are in a first position 68b, 68c, 68d and the switching valve 64a is in a second position 70a, the first intake valve 34b can be in an open position and exhaust valve 134a can be closing, while the remaining valves 34a, 34c, 34d, 134b, 134c, 134d remain closed. When the crankshaft is in the 400° position and the switching valves 64b, 64c, 64d are in a first position 68b, 68c, 68d and the switching valve 64a is in a second position 70a, the third exhaust valve 134c can be in an open position and the second intake valve 34b can be closing, while the remaining valves 34a, 34c, 34d, 134a, 134b, 134d remain closed. When the crankshaft is in the 540° position and the switching valves 64a, 64c, 64d are in a first position 68a, 68c, 68d and switching valve 64b is in a second position 70b, the fourth intake valve 34d can be in an open position and the third exhaust valve 134c can be closing, while the remaining valves 34a, 34b, 34c, 134a, 134b, 134d remain closed. When the crankshaft is in the 580° position and the switching valves 64a, 64c, are in a first position 68a, 68c and switching valves 64b, 64c are in a second position 70b, 70c, the second exhaust valve 134b can be in an open position and the fourth intake valve 34d can be closing, while the remaining valves 34a, 34b, 34c, 134a, 134c, 134d remain closed.

The plurality of intake valves 34a, 34b, 34c, 34d are operable in response to rotation of the first connecting rod 62 and can correspond to intake valves associated with each cylinder of a four cylinder internal combustion engine. The plurality of exhaust valves 134a, 134b, 134c, 134d are operable in response to rotation of the second connecting rod 162 and can correspond to exhaust valves 134a, 134b, 134c, 134d associated with each cylinder of the four cylinder internal combustion engine. The master pistons 38a, 38b can rotate between first and second positions in response to rotation of the crankshaft rotating the connecting rod 62, 162 around the crankpins 165a, 165b via the corresponding rod bearings 166a, 166b.

It should be recognized by those skilled in the art that the single switching valve 64a, 64b, 64c, 64d can be replaced with two separate open/closed valves, where a separate switching valve is provided for each intake valve, without departing from the disclosure of the present invention. It should also be recognized by those skilled in the art that additional connecting rods and rod bearings coupled to corresponding crankpins on the crankshaft can be provided to control operation of the valves of additional cylinders in a similar manner to that described above without departing from the disclosure of the present invention. It should further be recognized by those skilled in the art, that additional master piston/chambers and closed fluid flow paths can be provided similar to the disclosure above to provide hydraulic valve actuation of the valves individually or in pairs without departing from the disclosure of the present invention. Finally, it should be recognized by those skilled in the art that the four stroke-four cylinder engine cycle is by way of example and not limitation, since the crankshaft driven valve actuation system can be modified to accommodate different engine configurations, such as by way of example and not limitation, two or more cylinder engine configurations, such as three cylinder, six cylinder, eight cylinder, or more than eight cylinder engine configurations without departing from the disclosure of the present invention.

As illustrated in FIG. 1, the crankshaft driven valve actuation system 30 can further include a control system or electronic control unit (ECU) 98 for operation. As illustrated by dashed lines, the ECU 98 can be in electrical communication with the at least one control valve 56a, 56b, 56c, 56d and the at least one switching valve 64a, 64b, 64c, 64d. The electronic control unit 98 can include a microprocessor operated in accordance with a control program stored in memory. By way of example and not limitation, the ECU 98 can control the actuation of the at least one first control valve 56a, 56b, 56c, 56d and the at least one switching valve 64a, 64b, 64c, 64d in accordance with the detailed description above.

Advantages of implementing the disclosed crankshaft driven valve actuation system 30 in an engine can include weight savings by eliminating additional components such as camshafts, cam sensors, oil control valves, phasers, guides, timing chains, tensioners, sprockets, bearing caps, and miscellaneous bolts and fasteners. The disclosed crankshaft driven valve actuation system 30 can also reduce parasitic losses in the engine resulting from the use and wear of the additional components. The package size of the engine can also be reduced significantly by particularly removing camshafts. The disclosed crankshaft driven valve actuation system 30 can provide significant economic advantages by reducing production costs associated with the engine due to removing the cost of the additional components. The use of multiple control valves and connecting rods can also provide flexibility of intake and exhaust valve motion control through selection of the desired number of independent reciprocal pressurized fluid flow reciprocal paths.

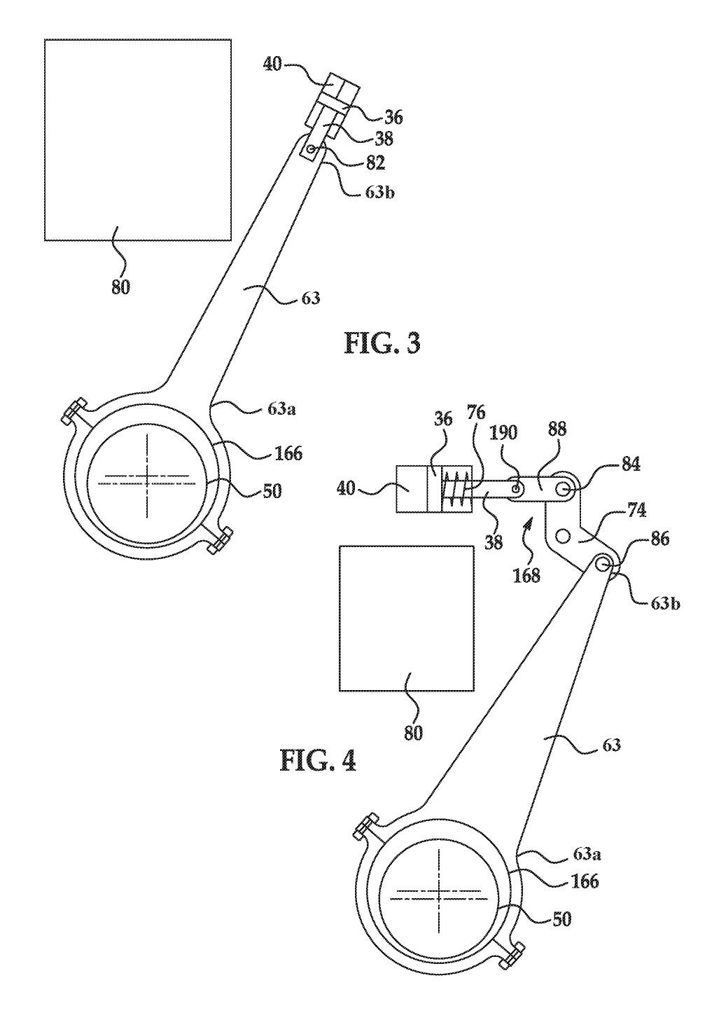

Referring now to FIGS. 2-4, a connecting rod 62 operable between a crankshaft 50 and a master piston 38 is illustrated. The connecting rod 62 and master piston 38 can be configured at various locations with respect to an engine piston 80, as seen in FIGS. 3-4. A slave piston 44a can open the corresponding exhaust valve 34a. The slave piston 44a can be actuated by the master piston 38 hydraulically linked to the slave piston 44a. The master piston 38 can be mechanically actuated by the connecting rod 62 which can be timed with a stroke of the engine piston 80, illustrated in FIGS. 3-4. By way of example and not limitation, the valve actuation system 30 can include a single connecting rod 62 for operation of one of the eight valves associated with a four cylinder engine. As best illustrated in FIG. 3, the connecting rod 62 can include a first and second end 62a, 62b. The first end 62a can be mounted for rotation with respect to the crankshaft 50 on a crankpin 165 by a rod bearing 166. The rod bearing 166 can be rotatable about a secondary longitudinal rotational axis. The secondary longitudinal rotational axis can be offset from a primary longitudinal rotational axis of the crankshaft 50. The second end 62b can be engageable with the master piston 38. The master piston 38 can include a piston pin 82 for driving the master piston 38 in reciprocal movement. As illustrated in FIG. 4, the connecting rod 62 can include a linkage mechanism 168 interposed between the connecting rod 62 and the master piston 38 for transferring reciprocal motion to the master piston 38. The first end 62a can be mounted for rotation to a rod bearing 166 and the second end 162b can be pivotally connected with the linkage mechanism 168 by pivot pin 86. The linkage mechanism 168 can include a rocker arm link 74 pivotally mounted for angular reciprocation. The rocker arm link 74 can include a first pivot pin 84 and a second pivot pin 86 for pivotally connecting to a linkage member 88 at one end of the rocker arm link 74 and for pivotally connecting to the connecting rod 62 at another end of the rocker arm link 74. The linkage member 88 can be connected to the master piston 38 by a third pivot pin 90 such that the rocker arm link 74 can pivot for reciprocating the master piston 38 between first and second end limits of travel. As illustrated in FIG. 4, the master piston 38 can further include at least one biasing spring 76 engageable with the master piston 38 accommodating for non-cyclical movement of the master piston 38 in the fluid pumping chamber 40 with respect to the linkage mechanism 68. The at least one biasing spring 76 can be in parallel or in series with the master piston 38. The biasing spring 76 can be located inside or outside the fluid pumping chamber 40. The at least one biasing spring 76 can eliminate backlash for improving noise and vibration in the valve actuation system 30.

In operation, rotating the crankshaft 50 of the internal combustion engine about a primary longitudinal rotational axis rotates the crankpins 165a, 165b about a secondary longitudinal rotational axis offset from the primary longitudinal axis. The rotation of the crankpins 165a, 165b can transfer movement to the connecting rods 62, 162 for reciprocating the master pistons 38a, 38b within the corresponding fluid pumping chambers 40a, 40b, 40c, 40d. The fluid pumping chambers 40a, 40b, 40c, 40d provide reciprocal fluid flow within fluid passages 72a, 72b, 172a, 172b to be selectively directed by control valves 56a, 56b, 56c, 56d, 64a, 64b, 64c, 64d associated with corresponding accumulators 46a, 46b, 46c, 46d and valves 34a, 34b, 34c, 34d, 134a, 134b, 134c, 134d located in the crankshaft driven valve actuation system 30 for driving each of the valves 34a, 34b, 34c, 34d, 134a, 134b, 134c, 134d between a normally open position and a closed position. Reciprocation of the master piston 38a, 38b can reciprocally drive fluid out of and draw working fluid back into the fluid pumping chambers 40a, 40b, 40c, 40d for providing reciprocal fluid flow within a closed fluid flow path in fluid communication with control valves 56a, 56b, 56c, 56d, 64a, 64b, 64c, 64d.

A fluid reservoir or sump 90a, 90b, 90c, 90d can provide fluid to a fluid pump 92a, 92b, 92c, 92d for delivery through a check valve 96a, 96b, 96c, 96d to the accumulator 46a, 46b, 46c, 46d. When the control valves 56a, 56b, 56c, 56d are in a first position, the corresponding accumulator 46a, 46b, 46c, 46d is isolated from the corresponding reciprocal fluid flow passages 72a, 72b, 172a, 172b. When the control valves 56a, 56b, 56c, 56d are in a second position 62a, 62b, 62c, 62d, the corresponding accumulator 46a, 46b, 46c, 46d is placed in fluid communication with the corresponding reciprocal fluid flow passages 72a, 72b, 172a, 172b. The accumulators 46a, 46b, 46c, 46d can operate as a lost fluid motion reservoir when modification or elimination of a valve actuation curve is desired during reciprocal fluid flow from the particular fluid pumping chambers 40a, 40b, 40c, 40d of a corresponding fluid pump 36a, 36b, while also acting as a pressurized fluid reservoir for holding a volume of fluid under pressure and for maintaining the fluid pressure and volume in the crankshaft driven valve actuation assembly 30. In other words, the accumulator 46a, 46b, 46c, 46d can be used to modify the shape of a valve timing curve and allow for lost motion in the hydraulic system by reducing motion of a valve while directing fluid flow to the corresponding accumulator 46a, 46b, 46c, 46d. The inclusion of the accumulator 46a, 46b, 46c, 46d in the system can allow a valve in fluid communication with the accumulator to open late, close early, open partially, or prevent opening of the valve all together. The accumulator 46a, 46b, 46c, 46d can include an accumulator spring 47a, 47b, 47c, 47d for maintaining pressure of a predetermined volume of fluid in the absence of pump 92a, 92b, 92c, 92d running. The accumulator 46a, 46b, 46c, 46d can provide fluid flow to the hydraulic valve actuation assembly 30 when the corresponding control valve 56a, 56b, 56c, 56d is in a second valve position 62a, 62b, 62c, 62d.

The fluid can flow through the high-speed switching valves 64a, 64b, 64c, 64d provides for selective fluid communication between the master piston 38a, 36b and a corresponding one of the plurality of slave piston 44a, 44b, 44c, 44d, 144a, 144b, 144c, 144d corresponding to a valve 34a, 34b, 34c, 34d, 134a, 134b, 134c, 134d, respectively. The switching or skipping function can be used to make use of the lost fluid motion that would otherwise occur when controlling a single engine valve function with the crankshaft driven valve actuation system 30. It is contemplated that more than one switching valve 64a, 64b, 64c, 64d could be used with an internal combustion engine having additional cylinders and valves. The control valve 56a, 56b, 56c, 56d can be in the second valve position 62a, 62b, 62c, 62d providing for fluid flow between the fluid piston pump 36a, 36b and a corresponding accumulator 46a, 46b, 46c, 46d. The control valve 56a, 56b, 56c, 56d can be in the first valve position 60a, 60b, 60c, 60d isolating the corresponding accumulators 46a, 46b, 46c, 46d from the reciprocal fluid flow passages 72a, 72b, 172a, 172b, while providing fluid communication between the fluid piston pump 36a, 36b and a corresponding control valve 64a, 64b, 64c, 64d for selected fluid communication with one of a pair of valves 34a or 34b; 34c or 34d; 134a or 134b; 134c or 134d depending on the position of the control valve 64a, 64b, 64c, 64d. Each valve 34a, 34b, 34c, 34d, 134a, 134b, 134c, 134d can include a corresponding slave piston 44a, 44b, 44c, 44d, 144a, 144b, 144c, 144d. The slave piston 44a, 44b, 44c, 44d, 144a, 144b, 144c, 144d can be normally biased toward a valve closed position by a corresponding biasing spring 48a, 48b, 48c, 48d, 148a, 148b, 148c, 148d. When the slave piston 44a, 44b, 44c, 44d, 144a, 144b, 144c, 144d is moved in response to fluid communication with pressurized fluid, the pressurized fluid can overcome the spring force to move the corresponding slave piston 44a, 44b, 44c, 44d, 144a, 144b, 144c, 144d and open the corresponding valve 34a, 34b, 34c, 34d, 134a, 134b, 134c, 134d. Fluid can be returned from the cylinder of a slave piston 44a, 44b, 44c, 44d, 144a, 144b, 144c, 144d back to the corresponding fluid pumping chamber 40a, 40b, 40c, 40d by passing back through the corresponding control valve 64a, 64b, 64c, 64d or through optional corresponding check valves 80b, 80c, 80d, 80e, 180b, 180c, 180d, 180e. Fluid flowing toward the switching valves 64a, 64b, 64c, 64d can be prevented from flowing to cylinders of the slave valves by corresponding check valves 80b, 80c, 80d, 80e, 180b, 180c, 180d, 180e.

A method of assembling a crankshaft driven valve actuation system 30 for controlling opening and closing a plurality of hydraulically actuated valves, either intake valves 34a, 34b, 34c, 34d or exhaust valves 134a, 134b, 134c, 134d, can be corresponding to a plurality of cylinders in an internal combustion engine. The crankshaft driven valve actuation system 30 can include a crankshaft 50 driven by the engine and rotatable about a primary longitudinal rotational axis, a fluid piston pump 36a, 36b driven by the crankshaft rotation for providing a source or pressurized fluid with reciprocal flow, an engine valve responsive to the reciprocal flow of the pressurized fluid to move from a normally closed position to an open position, and at least one accumulator 46, 46a, 46b, 46c, 46d for maintaining a predetermined volume of pressurized fluid. The method can include connecting a connecting rod 62, 62a, 62b to the crankshaft 50 for converting rotary movement into reciprocating movement driven by rotation of the crankshaft 50, assembling at least one fluid piston pump 36, 36a, 36b for reciprocation in response to reciprocating movement of the connecting rod 62, 62a, 62b by the crankshaft 50, fluidly connecting the at least one fluid pressure pump 36, 36a, 36b to at least one fluid passage 72a, 72b, 172a, 172b for directing reciprocal fluid flow of pressurized fluid from the at least on fluid pressure pump 36, 36a, 36b, 36c, 36d in fluid communication with at least one slave piston actuator 44a, 44b, 44c, 44d, 144a, 144b, 144c, 144d of a corresponding engine valve 34a, 34b, 34c, 34d, 134a, 134b, 134c, 134d to be controlled; and inserting at least one control valve 56a, 56b, 56c, 56d for selectively providing fluid communication between the at least one piston pump 36, 36a, 36b and at least one accumulator 46a, 46b, 46c, 46d for lost motion reciprocal fluid flow of pressurized fluid.

The method can further include connecting a linkage mechanism 168 between a fluid piston pump 36 and a connecting rod 62 for transferring reciprocal motion of the connecting rod 62 to drive fluid toward the at least one fluid passage 72a, 72b, 172a, 172b and to draw fluid from the at least one fluid passage 72a, 72b, 172a, 172b creating a reciprocal flow of pressurized fluid. The method can further include selectively providing fluid communication during reciprocal fluid flow within the at least one fluid passage 72a, 72b, 172a, 172b with at least one slave piston actuator 44a, 44b, 44c, 44d, 144a, 144b, 144c, 144d to actuate a corresponding engine valve 34a, 34b, 34c, 34d, 134a, 134b, 134c, 134d. The method can further include assembling a master piston 38, 38a, 38b for reciprocation within a fluid pumping chamber 40, 40a, 40b of the a fluid pressure piston pump 36, 36a, 36b for generating reciprocal fluid flow in response to rotation of the connecting rod 62, 162.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

1. In a crankshaft driven valve actuation system (30) for controlling opening and closing of a hydraulically actuated engine valve (34a, 34b, 34c, 34d, 134a, 134b, 134c, 134d) allowing fluid flow with respect to a cylinder of an internal combustion engine, the improvement comprising:
a crankshaft (50) driven by the internal combustion engine and rotatable about a primary longitudinal rotational axis;
a fluid piston pump (36a, 36b) driven by rotation of the crankshaft (50) for generating a reciprocating fluid flow in response to rotation of the crankshaft (50);
a slave piston actuator (44a, 44b, 44c, 44d, 144a, 144b, 144c, 144d) for operating an engine valve (34a, 34b, 34c, 34d, 134a, 134b, 134c, 134d) moveable from a normally closed position to an open position in response to the reciprocating fluid flow;
an accumulator (46, 46a, 46b, 46c, 46d) for storing a volume of fluid under pressure; and
a control valve (56a, 56b, 56c, 56d) for selectively providing fluid communication between the accumulator (46, 46a, 46b, 46c, 46d) and the fluid piston pump (36a, 36b) to modify a valve timing actuation curve of the engine valve (34a, 34b, 34c, 34d, 134a, 134b, 134c, 134d) during reciprocating fluid flow.

2. The improvement of claim 1, wherein the fluid piston pump (36a, 36b) further comprises:
a connecting rod (63, 162) connected to a crankpin (165a, 165b) of the crankshaft (50);
a master piston (38a, 38b) connected to the connecting rod (62, 162) defining a fluid pumping chamber (40a, 40b, 40c, 40d) for driving fluid out of and for drawing fluid into the fluid pumping chamber (40a, 40b) in reciprocating fluid flow in response to reciprocation of the master piston (38a, 38b) by rotation of the crankshaft (50).

3. The improvement of claim 2, wherein the fluid piston pump (36a, 36b) further comprises:
the master piston (38a, 38b) defining first and second pumping chambers (40a, 40b, 40c, 40d) located on opposite sides of the master piston (38a, 38b) for driving fluid out of one of the first and second pumping chambers (40a, 40b, 40c, 40d) while simultaneously drawing fluid into another of the first and second pumping chambers (40a, 40b, 40c, 40d) in reciprocating fluid flow during reciprocation of the master piston (38a, 38b) in both directions.

4. The improvement of claim 2 further comprising:
a linkage mechanism (168) connected between the master piston (38a, 38b) and the connecting rod (62, 162) for transferring reciprocal movement of the connecting rod (62, 162) to the master piston (38a, 38b).

5. The improvement of claim 1 further comprising:
a switching valve (64a, 64b, 64c, 64d) located between the fluid piston pump (36a, 36b) and the slave piston actuator (44a, 44b, 44c, 44d, 144a, 144b, 144c, 144d) of the engine valve (34a, 34b, 34c, 34d, 134a, 134b, 134c, 134d) for selectively providing fluid communication between the fluid piston pump (36a, 36b) and the slave piston actuator (44a, 44b, 44c, 44d, 144a, 144b, 144c, 144d) of the engine valve (34a, 34b, 34c, 34d, 134a, 134b, 134c, 134d).

6. The improvement of claim 1 further comprising:
a fluid passage (72, 72a, 72b, 172a, 172b) in fluid communication between the fluid piston pump (36, 36a, 36b), the control valve (56, 56a, 56b, 56c, 56d), and the slave piston actuator (44a, 44b, 44c, 44d, 144a, 144b, 144c, 144d) of the engine valve (34a, 34b, 34c, 34d, 134a, 134b, 134c, 134d).

7. A method for controlling opening and closing of a hydraulically actuated engine valve (34a, 34b, 34c, 34d, 134a, 134b, 134c, 134d) allowing fluid flow with respect to a cylinder of an internal combustion engine, the method comprising:
generating a reciprocating fluid flow with a fluid pumping chamber (40a, 40b, 40c, 40d) of a fluid piston pump (36a, 36b) attached to a crankshaft (50) by a connecting rod (62, 162) in response to rotation of the crankshaft (50);
driving an engine valve (34a, 34b, 34c, 34d, 134a, 134b, 134c, 134d) between an open position and a closed position in response to communication with the reciprocating fluid flow from the fluid pumping chamber (40) of the fluid piston pump (36a, 36b) with a slave piston actuator (44a, 44b, 44c, 44d, 144a, 144b, 144c, 144d) of an engine valve (34a, 34b, 34c, 34d, 134a, 134b, 134c, 134d); and
selectively providing fluid communication between the fluid piston pump (36a, 36b) and an accumulator (46a, 46b, 46c, 46d) with a control valve (56a, 56b, 56c, 56d) for modifying a valve timing actuation curve of the engine valve (34a, 34b, 34c, 34d, 134a, 134b, 134c, 134d) during reciprocal fluid flow.

8. The method of claim 7 further comprising:
selectively providing fluid communication between one of a first and second hydraulically actuated valve (34a, 34b, 34c, 34d, 134a, 134b, 134c, 134d) and the reciprocal fluid flow generated by the at least one fluid piston pump (36, 36a, 36b, 36c, 36d) to drive the valve (34a, 34b, 34c, 34d, 134a, 134b, 134c, 134d) to be controlled toward an open position with at least one switching valve (64a, 64b, 64c, 64d).

9. The method of claim 7 further comprising:
connecting a connecting rod (62, 162) to a crankpin (165a, 165b) of the crankshaft (50);
connecting a master piston (38a, 38b) to the connecting rod (62, 162) defining a fluid pumping chamber (40a, 40b, 40c, 40d) for driving fluid out of and for drawing fluid into the fluid pumping chamber (40a, 40b) in reciprocating fluid flow in response to reciprocation of the master piston (38a, 38b) by rotation of the crankshaft (50).

10. The method of claim 9 further comprising:
driving fluid out of one of the first and second pumping chambers (40a, 40b, 40c, 40d) while simultaneously drawing fluid into another of the first and second pumping chambers (40a, 40b, 40c, 40d) in reciprocating fluid flow during reciprocation of the master piston (38a, 38b) in both directions with the master piston (38a, 38b) defining first and second pumping chambers (40a, 40b, 40c, 40d) located on opposite sides of the master piston (38a, 38b).

11. The method of claim 9 further comprising:
connecting a linkage mechanism (168) between the master piston (38a, 38b) and the connecting rod (62, 162) for transferring reciprocal movement of the connecting rod (62, 162) to the master piston (38a, 38b).

12. The method of claim 7 further comprising:
connecting a switching valve (64a, 64b, 64c, 64d) between the fluid piston pump (36a, 36b) and the slave piston actuator (44a, 44b, 44c, 44d, 144a, 144b, 144c, 144d) of the engine valve (34a, 34b, 34c, 34d, 134a, 134b, 134c, 134d) for selectively providing fluid communication between the fluid piston pump (36a, 36b) and the slave piston actuator (44a, 44b, 44c, 44d, 144a, 144b, 144c, 144d) of the engine valve (34a, 34b, 34c, 34d, 134a, 134b, 134c, 134d).

13. The method of claim 7 further comprising:
providing fluid communication between the fluid piston pump (36, 36a, 36b), the control valve (56, 56a, 56b, 56c, 56d), and the slave piston actuator (44a, 44b, 44c, 44d, 144a, 144b, 144c, 144d) of the engine valve (34a, 34b, 34c, 34d, 134a, 134b, 134c, 134d) with a fluid passage (72, 72a, 72b, 172a, 172b).

14. A method of assembling a crankshaft driven valve actuation system (30) for controlling opening and closing a hydraulically actuated engine valve (34a, 34b, 34c, 34d, 134a, 134b, 134c, 134d) allowing fluid flow with respect to a cylinder of an internal combustion engine, the method comprising:
connecting a connecting rod (62, 162) to a crankpin of a crankshaft (50) for movement in response to rotation of the crankshaft (50);
assembling at least one fluid piston pump (36) for reciprocation in response to movement of the connecting rod (62, 162) by the crankshaft (50) for generating a reciprocal fluid flow;
connecting the at least one fluid pressure pump (36, 36a, 36b, 36c, 36d) to at least one fluid passage (72a, 72b, 172a, 172b) for directing reciprocal fluid flow from the at least on fluid pressure pump (36, 36a, 36b, 36c, 36d) in fluid communication with at least one hydraulically actuated valve (34a, 34b, 34c, 34d, 134a, 134b, 134c, 134d) to be controlled; and
inserting at least one control valve (56a, 56b, 56c, 56d) between the at least one accumulator (46a, 46b, 46c, 46d) and the at least one fluid piston pump (36a, 36b) for modifying a valve timing actuation curve of the engine valve (34a, 34b, 34c, 34d, 134a, 134b, 134c, 134d) during reciprocal fluid flow.

15. The method of claim 14 further comprising:
inserting at least one switching valve (64a, 64b, 64c, 64d) for selectively providing fluid communication between one of a first and second hydraulically actuated valve (34a, 34b, 34c, 34d, 134a, 134b, 134c, 134d) and the reciprocal fluid flow generated by the at least one fluid piston pump (36, 36a, 36b, 36c, 36d) to drive the valve (34a, 34b, 34c, 34d, 134a, 134b, 134c, 134d) to be controlled toward an open position.
